(19) United States
(12) Patent Application Publication
(10) Pub. No.: US 2008/0098603 A1
(43) Pub. Date: May 1, 2008

(54) SHAVING IMPLEMENT HAVING A MOVING BLADE

(75) Inventors: David Noble, Wallingford, CT (US); Andrew J. Pennella, Stamford, CT (US)

Correspondence Address: Michaud-Duffy Group LLP, 306 Industrial Park Road, Suite 206, Middletown, CT, 06457, US

(73) Assignee: EVEREADY BATTERY COMPANY, INC., St. Louis, MO (US)

(21) Appl. No.: 11/953,102

(22) Filed: Dec. 10, 2007

Related U.S. Application Data
(62) Division of application No. 11/399,074, filed on Apr. 5, 2006.
(60) Provisional application No. 60/668,761, filed on Apr. 5, 2005.

(51) Int. Cl. B26B 19/28; B26B 21/00

(52) U.S. Cl. 30/44; 30/42; 30/523

(57) ABSTRACT

The present invention is related to a shaving implement that includes at least a razor cartridge and a mechanism. The razor cartridge includes at least one blade that has a sharpened cutting edge and defines a blade plane. The mechanism is disposed in the shaving plane and moves the blade in the blade plane during shaving. The mechanism may be either a vibration mechanism (i.e., a motorized spinning eccentric weight), or a dithering mechanism (i.e., a piezoelectric element). The cut force required to shave, when the blades are moving in the blade plane, is significantly reduced.

### CROSS REFERENCE TO RELATED APPLICATIONS

This patent application is a divisional of U.S. patent application Ser. No. 11/399,074, entitled “Shaving Implement Having A Moving Blade,” filed Apr. 5, 2006, which is entitled to the benefit of and incorporates by reference the disclosure of U.S. Patent Application 60/668,761 filed on Apr. 5, 2005, entitled “Shaving Implement Having a Moving Blade.”

### BACKGROUND OF THE INVENTION

1. Field of the Invention

The present invention relates generally to shaving implements, and more particularly, to shaving implements having at least one moving blade.

2. Description of the Prior Art

In general, shaving implements, also commonly referred to as wet-shave devices, attempt to simultaneously satisfy three important functional areas: comfort, closeness, and safety. Over the years, new technologies have been utilized in shaving implement designs to improve closeness and safety, and, in general, make such shaving implements more efficient at their intended task. Efforts to date have not been entirely successful, typically due to the difficulties posed by the “cut force” of the razors during shaving. “Cut force” is the force required to sever a material (e.g., hair) when a razor blade is moved through that material at a constant velocity. Typically, the cut force is affected by friction between the razor blade and the material. Friction between a hair and the razor blade is often the source of unpleasant pulling on the hair during shaving.

It is known to reduce cut force by altering the geometry of the razor blade. For example, reducing the tip diameter of the cutting edge of the razor cartridge has been shown to successfully reduce the cut force. However, reducing the tip diameter of a razor blade has adverse effects, as well. For example, a blade that has a cutting edge that is too sharp poses safety issues, and can lead to nicks and cuts. Therefore, reducing the tip diameter has proven to have limited success.

To this point, the most significant efforts in improving shaving comfort have involved lubrication to reduce friction and to mitigate the pulling action on the hair. For example, many shaving implements utilize various blade coatings on the outer surface of the blades, which effectively reduce the friction between the blades and the hair during shaving. Additionally, many shaving implements now employ comfort strips adjacent the blades that act to lubricate, moisturize, and, in some cases, medicate the skin during, or just after, the shaving process. However, these additions have had little effect on cut force.

It is, therefore, an object of the present invention to overcome the known shortcomings of the prior art.

### SUMMARY OF THE DISCLOSURE

The present invention is related to a shaving implement that includes at least a razor cartridge and a mechanism. The razor cartridge includes at least one blade that has a sharpened cutting edge and defines a blade plane. The mechanism is disposed in the shaving plane and moves the blade in the blade plane during shaving.

In one embodiment of the present invention, the present invention further includes a handle that is releasably coupled to the razor cartridge, the handle having vibration mechanism therein. The vibration mechanism can be an eccentric weight that spins on an axis, the axis being oriented in a manner that is generally perpendicular to the blade plane. Therefore, when the eccentric weight spins, the handle, and accordingly the razor cartridge vibrate such that the at least one blade moves in the blade plane.

In another embodiment of the present invention, the razor cartridge above described razor cartridge includes a housing defining an interior chamber, the housing being releasably coupled to a razor handle. A dithering mechanism is disposed within the interior chamber and is operatively connected to the dithering mechanism. The dithering moves the at least one blade in the blade plane.

In either of the embodiments described above, the razor cartridge may include more than one razor blade. The razor blades are preferably oriented generally parallel to one another. Therefore, the vibration mechanism, or the dithering mechanism, moves more than one blade in the blade plane during normal use.

One advantage of the present invention is that the when the blade(s) move in the blade plane, the blade(s) tend to chop the hair. Accordingly, the cut force required to shave, when the blades are moving in the blade plane, is significantly reduced. Therefore, the shave tends to be closer and more comfortable, without sharpening the one or blades to an unsafe degree.

These and other advantages will be apparent to one of skill in the art in light of the Detailed Description and Drawings.

### BRIEF DESCRIPTION OF THE DRAWINGS

FIG. 1 is a perspective view of a typical shaving implement;

FIG. 2 is a enlarged cross-sectional view of FIG. 1, depicting the blade plane;

FIG. 3 is a perspective view of one embodiment of the present invention;

FIG. 4 is a sectional view of FIG. 3 along line 4-4;

FIG. 5 is an enlarged view of area 5 of FIG. 4, depicting the blade plane and the axis of rotation;

FIG. 6 is a perspective view of another embodiment of the present invention, with the razor cartridge detached from the handle;

FIG. 7 is an exploded view of the components of a razor cartridge of the present invention;

FIG. 8 depicts a partially constructed razor cartridge of the present invention exposing the positioning of the dithering mechanism within the razor cartridge;

FIG. 9 is a cross-sectional view of the razor cartridge of FIG. 6 taken along line 9-9.

### DETAILED DESCRIPTION

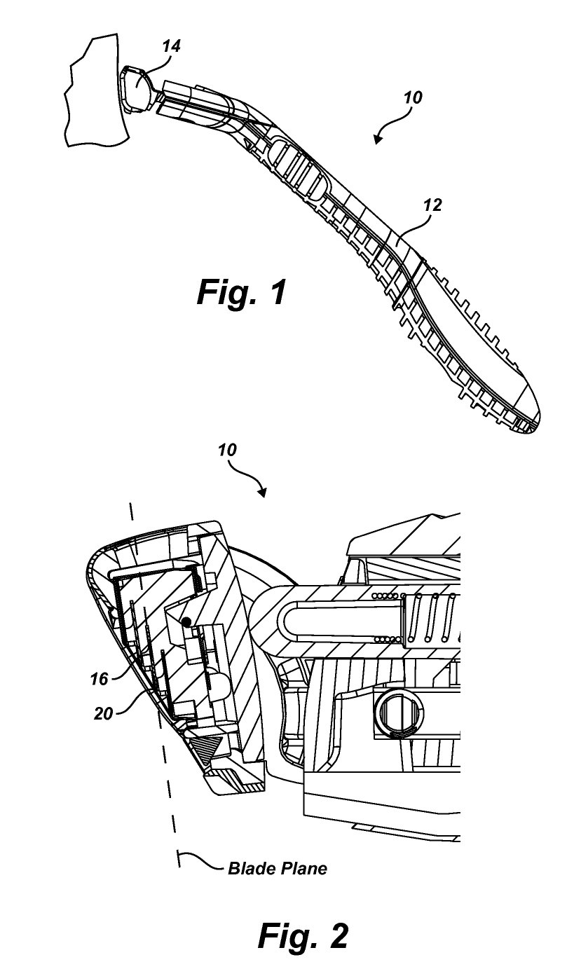

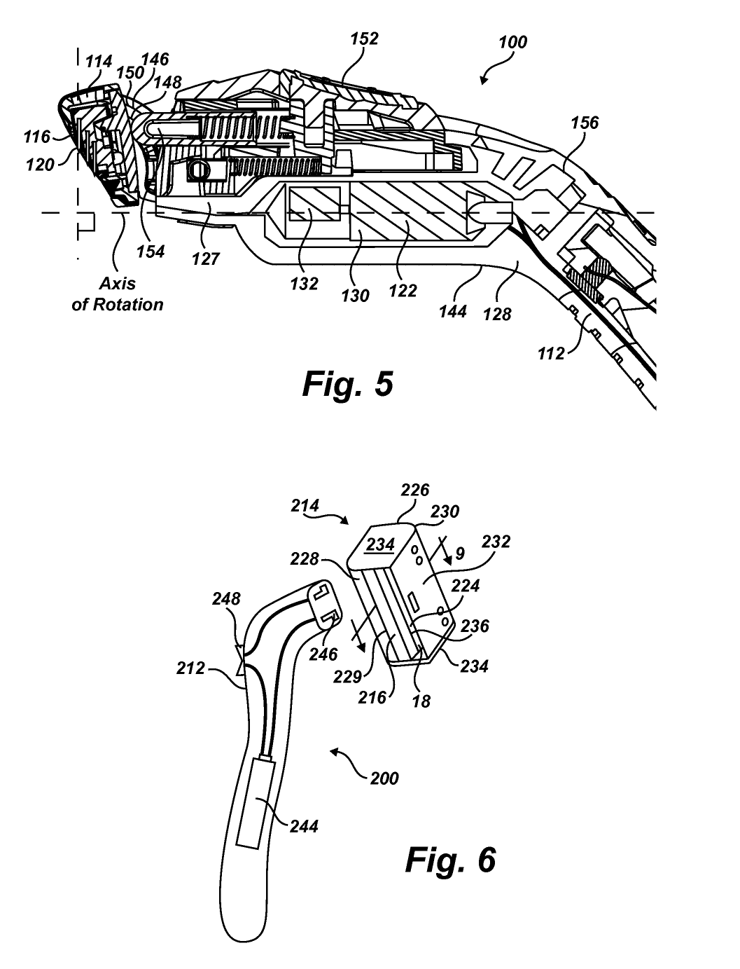

Referring to FIGS. 1 and 2, a shaving implement is generally referred to by the identifier 10. The shaving implement 10 includes a handle 12 that is releasably coupled to a razor cartridge 14. In all embodiments, the razor cartridge 14 includes at least one blade 16. The shaving implement 10 further includes a mechanism 18 (see FIGS. 4 or 6) that moves the one or more blades 16 in the blade plane during normal shaving. Each razor blade 16 includes a sharpened cutting edge 20 and defines a “blade plane” (see FIG. 2). The mechanism 18 may be of any suitable type known to those of skill in the art; however, it is preferable that the shaving implement 10 include either a vibration mechanism 122 (FIG. 5), or a dithering mechanism 224 (FIG. 6).

The present invention is disclosed herein in the form of two embodiments, the first embodiment (vibration mechanism 122) utilizes identifiers beginning with 100, and the second embodiment (dithering mechanism 224) utilizes identifiers beginning with 200.

### Embodiment 1

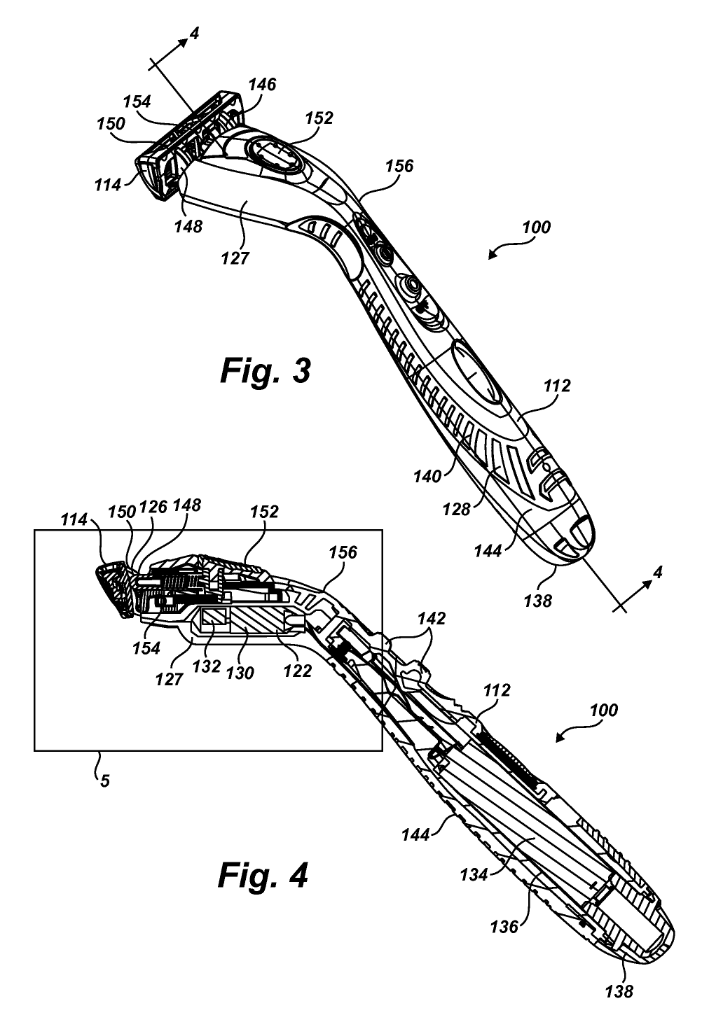

Referring to FIGS. 3-4, the shaving implement 100 includes a handle 112, and a razor cartridge 114. The razor cartridge 114 includes at least one blade 116 having a sharpened cutting edge 120, and defines a blade plane. The handle 112 includes a vibration mechanism 122, and a cartridge-connecting member 126.

Although the handle 112 of the shaving implement 110 of the present invention can be made in numerous manners, using numerous types of materials, the following manner has shown particular utility. The handle 112, in some embodiments such as the ones shown in FIGS. 4 and 5, can include a first molded portion 127, a vibration mechanism 122, and a second molded portion 128. The first molded portion 122 can be formed of a rigid molded material that provides the razor handle 112 with the necessary mechanical strength. For example, the first molded portion 127 may be made of Glass Fiber Polypropylene (“GFPP”), which has proven to have desirable density (1.00 g/cm³), tensile strength (87 MPa), and flexural strength (108 MPa), as well as an appropriate hardness (Rockwell Hardness R-scale 111). GFPP supplies a desirable balance of mechanical properties for providing the razor handle 112 with weight, structural stability, as well as an attractive finish. However, the first molded portion 127 may made of any suitable material. In fact, in some embodiments, the razor handle 112 is not made of a molded material.

Referring to FIGS. 4 and 5, the vibration mechanism 122 is a motor 130 that spins an eccentric weight 132, and is powered by a battery 134. The eccentric weight 132 spins about an Axis of Rotation (see FIG. 5) such that vibrations occur in the plane generally perpendicular to the Axis of Rotation. Preferably, the vibration mechanism 122 creates displacements or amplitudes of motion from about 0.01 mm to about 0.07 mm, when in contact with the user's face during normal shaving. The frequency of vibration of the vibration mechanism 122 may also be controlled, for example, by spinning the eccentric weight 132 at a desired frequency. Preferably, the frequency is within the range of about 50 to about 1000 Hz, and more preferably, between 100 Hz and 300 Hz is applied. In addition, the eccentric weight 132 that turns can vary in size depending on the mechanical properties of the handle 112, as well as the manner in which the vibration mechanism 122 is mounted in (or to) the handle 112. The battery 134 may be housed in a cavity 136 that is selectively accessible, as shown in FIG. 4, via a removable cap 138, or the battery 134 may be encased within the first and/or second molded portions 127, 128 of the razor handle 112 (e.g., in instances where the shaving implement 110 is disposable unit). The vibration mechanism 122 also includes wiring and/or an on/off switch, in order to make the vibration mechanism operable by the end user.

Referring back to FIG. 3, the vibration mechanism 122 (e.g., the spinning eccentric weight 132 and its associated electronics) is then secured to the first molded portion 127 and a second molded portion 128 is then molded over at least a portion of the first molded portion 127 and at least a portion of the vibration mechanism 122. Preferably, the vibration mechanism 122 is completely encased within the second molded portion 128 and the first molded portion 127. Completely encasing the vibration mechanism 122 within the second molded portion 128, the vibration mechanism 122 is substantially protected from coming into contact with water and other substances that may affect the operability of the device.

In some embodiments, the second molded portion 128 can be formed of thermoplastic rubber (“TPE”), and preferably VYRAM® rubber 9211-35W906 that is commercially available through Advanced Elastomer Systems (AES) of Akron, Ohio, USA. The TPE material identified above has desirable hardness (45 Shore A), specific gravity (0.92), (ultimate) tensile strength (3.0 MPa), (ultimate) elongation (450%). The TPE material also has desirable compressive qualities, which are useful for creating various razor handle features, such as, but limited to, gripping structures 140 (discussed infra). However, any suitable material known to those of skill in the art can be used in place of the above-identified material.

The second molded portion 128 may also be utilized to form additional features on the handle. For example, the second molded portion 128 may form features such as, but not limited to, gripping structures 140, and On/Off buttons (or other controls) 142 for the vibration mechanism 122. Furthermore, the second molded portion 128 may be a single, unitary piece, or may be several separate elements, as shown in FIG. 3.

Although the embodiments described above show the vibration mechanism 122 inside an outer surface 144 of the handle 112, the vibration mechanism 122 can also be attached to the razor handle 112 externally, in an alternative embodiment.

The razor handle 112 includes a cartridge-connecting member 146. The cartridge-connecting member 146 may any one of numerous types of cartridge connectors known in the art, and may connect to the cartridge 114 in either a fixed manner, or a pivotal manner. For example, as shown in FIGS. 4 and 5, the cartridge-connecting member 146 includes two journal bearings 148 which mate with complimentary connectors 150 on an associated razor cartridge 114. When connected, the razor cartridge 114 can pivot relative to the razor handle 112. Alternatively, an inter-connect member may be attached to the razor cartridge 114 such that the razor cartridge 114 pivots relative to the inter-connect. In these embodiments, the inter-connect member is fixedly attached in any suitable manner to the razor handle 112.

In most embodiments, the razor handle 112 further includes a release mechanism 152 and a biasing member 154. The biasing member 154 is operable to urge the razor cartridge 114 toward a rest position (see FIG. 3), but is able, by moving toward a retracted position (not shown), to allow the razor cartridge 114 to pivot relative to the handle 112 when forces are placed on the razor cartridge 114. The release mechanism 152 may be of any suitable type. In the embodiment shown, the release mechanism 152 pivots the cartridge connecting members 146 inward, which, in turn, releases the razor cartridge 114 from the handle 112.

Referring back to FIGS. 4 and 5, the vibration mechanism 122 (e.g. motorized 130 spinning eccentric weight 132) is preferably positioned within a close proximity to the razor cartridge 114. As shown, the handle 112 includes a neck 156, where the razor handle 114 bends to place the razor cartridge in a convenient location, at a convenient angle for normal shaving. Preferably, the vibration mechanism 122 is located between the neck 156 and the razor cartridge 114. In addition, the motorized 130 spinning eccentric weight 132 is oriented such that the Axis of Rotation is substantially perpendicular to the blade plane. Therefore, when the eccentric spinning 132 weight is turned, the resulting vibrations in the handle 112 translate to the attached razor cartridge 114 and move the at least one blade(s) 116 in the blade plane. The motion of the blade 116 in the blade plane effectively reduces the cut force of the blade. A reduction in cut force during shaving will provide the user with a more comfortable shave.

In addition, because the motorized 130 spinning eccentric weight 132 is located between the neck 156 and the razor cartridge 114, the vibrations caused by the vibration mechanism 122 are only minimally damped by the hand of the user. Therefore, the vibrations caused by the spinning eccentric weight 132 are typically more efficiently transferred to the razor cartridge 114 and, accordingly, the associated blade(s) 116 than an embodiment where the neck 156 of the razor handle 112 is between the razor cartridge 114 and the eccentric weight 132.

### Embodiment 2

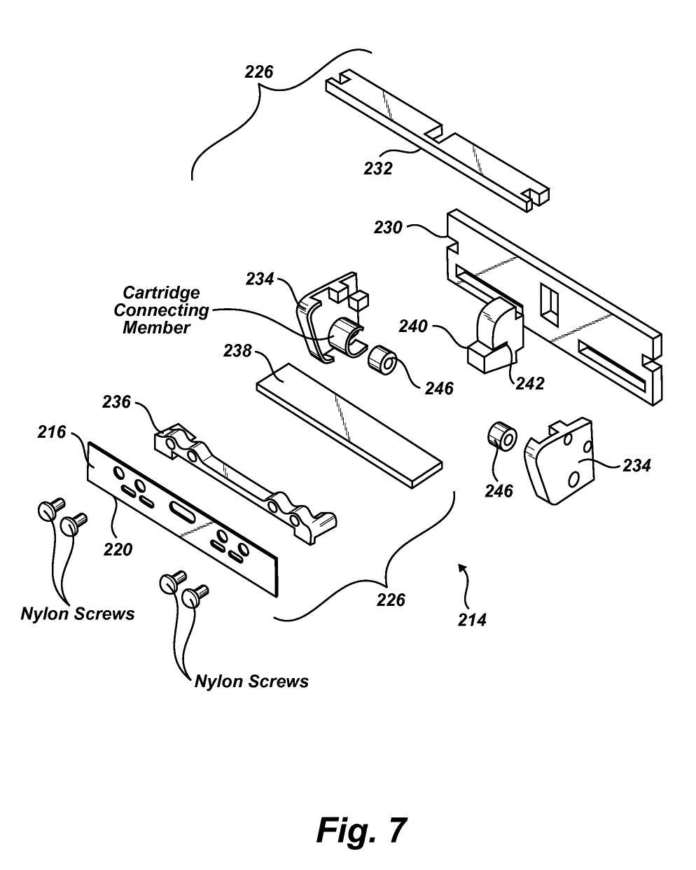

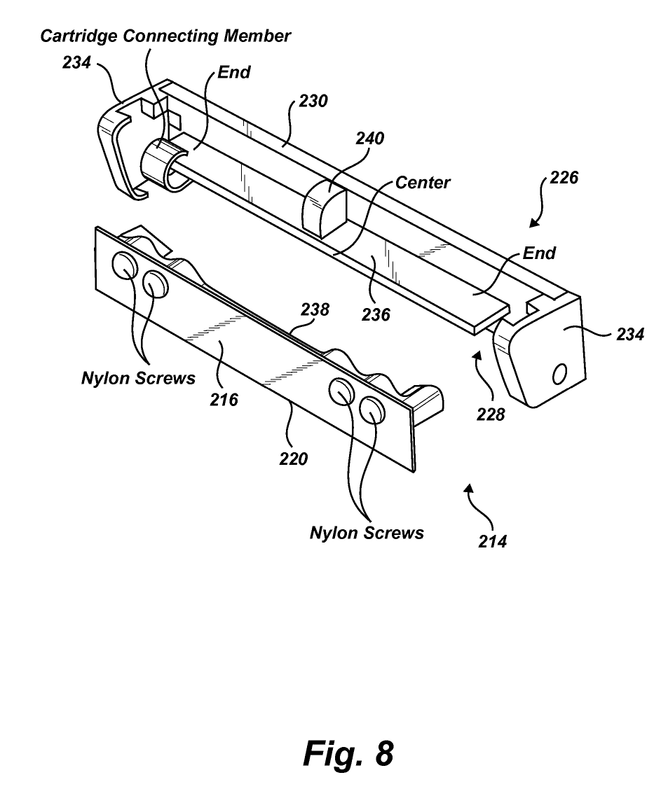

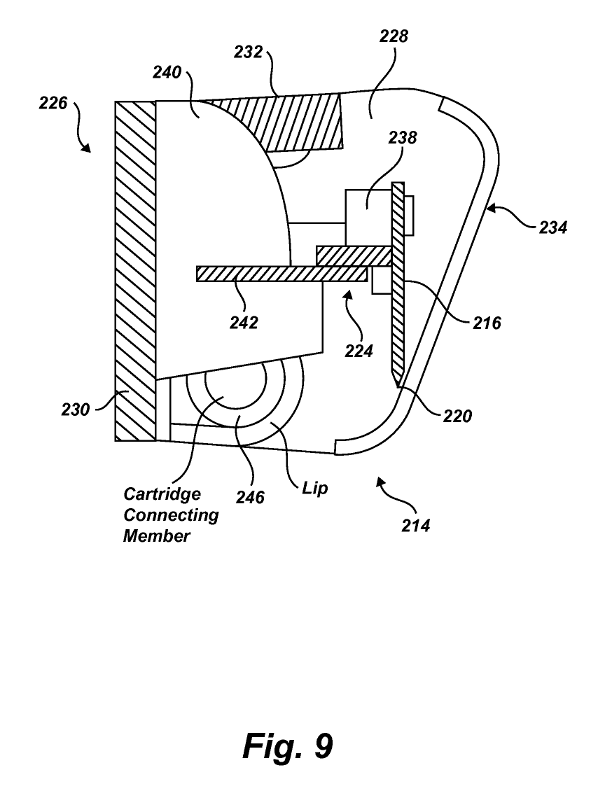

In a second embodiment of the present invention, and now referring to FIGS. 6-9, the shaving implement 200 includes a handle 212. In the second embodiment, the mechanism 18 is a dithering mechanism 224. In these embodiments, the cartridge 214 comprises a housing 226 defining an interior chamber 228 in which the razor blade 216 and the dithering mechanism 214 are mounted. As is known, the cartridge 214 can be pivotally connected to the handle 212, as discussed above with respect to the first embodiment. As shown more particularly in FIGS. 7 and 8, the housing 226 includes a back section 230, a top section 232, and generally opposed side sections 234. While the housing 226 is shown as having separably defined sections, the above-defined sections may be integrally formed (e.g., during a molding operation). The general shape of the housing 226 preferably sets the angle of the blade(s) 216 and, more particularly, the cutting edge 220 against the skin surface, as shown, for example, in FIG. 1.

The razor cartridge 214 can be secured to the handle 212 in any suitable manner, including, but not limited to, the manner described with respect to the first embodiment.

To ensure dynamic dithering capability of the present embodiment (i.e., movement of the at least one blade 216 during a shaving operation), the blade 216 is preferably mounted within the interior chamber 228 of the housing 226 substantially separate and free from any portion of the housing 226. The blade is operatively connected to the dithering mechanism 224, which is also enclosed by the housing 226. The dithering mechanism 224 generally comprises a piezoelectric element 236 operatively connected to a bridge member 238, which, in turn, is operatively connected to the razor blade 216.

A rib support 240 is mounted to the back section 230 of the housing 226 for holding the dithering mechanism 224 within the interior chamber 228. In particular, the piezoelectric element 236 is secured to the rib 240. However, only a portion of the piezoelectric element 236 is secured by the housing 226. At least a portion of the piezoelectric element 236 is unsecured, and thus permitted to displace when an electric field or a high voltage is applied thereto. As shown, the rib 240 is provided with a slot 242 that receives and positions the piezoelectric element 236 within the interior chamber 228 substantially normal to the back section 230 of the housing 226. Though shown in FIG. 7 as a separate piece, the rib 240 may be integrally molded to the back section 230.

In a preferred embodiment of the present invention, the rib 240 secures the center of the piezoelectric element 236 and permits the unsecured free ends thereof to flap when an electric field or a high voltage is applied to the piezoelectric element. In an alternative embodiment, the piezoelectric element 236 can be secured at its ends, and the center can be unsecured and free for displacement.

The bridge member 238 is connected to the piezoelectric element 236, preferably using an epoxy adhesive, so as to correspondingly flex and move with displacement of the piezoelectric element 236. Also connected to the bridge member 238 is the razor blade 216, preferably so that the blade 214 is positioned within the housing 226 substantially perpendicular to the piezoelectric element 236. The bridge member 238 will thus transfer or impart the displacement motion of the piezoelectric element 236 to the blade 216. With the blade 216 substantially perpendicular to the piezoelectric element 236, the flapping displacement of the element 236 will translate into movement of the blade 216 in the blade plane.

The bridge member 238 is shown in FIG. 7 as having a unique shape, though a variety of shapes are acceptable for the bridge member 238 as long as it transfers or imparts the displacement motion of the piezoelectric element 236 to the razor blade 216. Ideally, the bridge member 238 is compact and can easily fit into the cartridge 214 housing 226 without substantially increasing size or weight of the cartridge 214, or interfering with the cutting edge 220 of the blade 216. Additionally, a more compact bridge member 238 reduces the stress exerted on the piezoelectric element 236 and allows displacement motion with minimal encumbrances.

To effect transfer of the displacement motion from the piezoelectric element 236 to the razor blade 216, the bridge member is preferably constructed from a material permitting it to flex with the piezoelectric element, such as polycarbonate, though alternative materials may be used. In the preferred embodiment, the bridge member 238 is adhered to the unsecured ends of the piezoelectric element 236. Accordingly, the displacement of the piezoelectric element 236 along the ends imparts a like motion to the bridge member 238. Correspondingly, the blade 216 is connected to the bridge member 238 such that the motion of the bridge member 238 imparts a like motion to the blade 216. In alternative embodiments envisioned by the present invention, the bridge member 238 may be connected to the center of the piezoelectric element 236.

The blade 216 can be secured to the bridge member 238 using any of several known connection means, but preferably permitting easy detachment of the blade from the bridge member 238 when needed. As shown, the blade 216 is screwed to the bridge member 238, for example, with 0-80 nylon screws. Alternatively, and although not shown, the bridge member 238 may be provided with slots or similar support surfaces to accommodate one or more blades resting in such slots or on such support surfaces in a preferred orientation within the housing.

The piezoelectric element 236 is preferably a bimorph actuator. That is, the element comprises multiple piezoceramic sheets, e.g., zirconate titanate or lead magnesium niobate, plated with sheets of thin metal electrodes, e.g., brass. The actuation or displacement length of the piezoelectric element 236 can be varied by increasing or decreasing the layers of piezoceramic sheets stacked or laminated together. A vibration or displacement of the piezoelectric element 236 is produced when an electric field or a high voltage is applied across it. Preferably, the element 236 creates displacements or amplitudes of motion of up to about 100 microns. The frequency of vibration of the piezoelectric element 236 may also be controlled, for example, by applying a control voltage at a desired frequency. Preferably, a frequency within the range of about 50 to about 1000 Hz is applied. Such control over the displacement and frequency of the movement of the blade 216 results in a directed motion (as opposed to a random, uncontrolled vibration) that reduces the cut force of the blade. A reduction in cut force during shaving will provide the user with a more comfortable shave.

The electric field or voltage is applied to the piezoelectric element 236 from a power supply 244 located in the handle. Conductors 246 operatively connected to the piezoelectric element 236 are provided in each of the members connecting the cartridge 214 to the handle 212 to transfer the power from the power supply to the piezoelectric element 236. The conductors 246 are preferably shielded within the housing 226 so that the application of an electric field or high voltage to the piezoelectric element 236 will not shock the user or otherwise affect normal operation of the shaving implement of the present invention.

As is generally known with piezoelectric bimorphs, when an electric field or voltage is applied, the piezoelectric element 236 will band or deflect. When the center of the piezoelectric element 236 is secured by the rib 240, the unsecured ends are free to flap. The flapping motion of the piezoelectric element 236 transfers to the bridge member 238 and correspondingly to the blade 216. Such movement causes the blade 216 to dither, or move back-and-forth, in particular in the blade plane. That is, the blade 216 will move back-and-forth in the blade plane, thus reducing the friction between the cutting edge and the user's hair.

The power supply 244 is preferably provided in the handle 212 and is operated by a switch 248.

While a razor cartridge 214 has been shown to include a single blade 216, the present invention is not limited in this regard as a razor cartridge having more than one blade 216 is equally contemplated by the present invention. In addition, the present invention is not limited as to the specific type or structural form of razor shown in FIG. 1, the razor cartridge 214 design of the present invention being equally adaptable to a single use razor, a razor having a replaceable cartridge, or the like, without departing from the broader aspects of the present invention.

Modification and variations may be made to the disclosed embodiments without departing from the subject and spirit of the invention as defined by the following claims.

What is claimed is:

1. A shaving implement, comprising:
a razor cartridge having at least one generally planar razor blade, the at least one razor blade having a cutting edge and defining a blade plane;
a handle coupled to the razor cartridge; and
a mechanism disposed in the shaving implement for moving the at least one blade in the blade plane.

2. The shaving implement of claim 1, wherein the handle includes a vibration mechanism therein.

3. The shaving implement of claim 2, wherein the vibration mechanism is a motorized spinning eccentric weight that spins on an axis, the axis being oriented in a manner that is generally perpendicular to the blade plane.

4. The shaving implement of claim 1, wherein the handle includes a first molded portion and a second molded portion.

5. The shaving implement of claim 4, wherein the first molded portion is formed of a rigid molded material.

6. The shaving implement of claim 2, wherein the vibration mechanism is powered by a battery.

7. The shaving implement of claim 6, wherein the battery is housed in a cavity selectively accessible by a removable cap.

8. The shaving implement of claim 6, wherein the battery is encased in at least one of a first molded portion and a second molded portion.

9. The shaving implement of claim 2, including wiring and a switch.

10. The shaving implement of claim 4, wherein the second molded portion is formed of a thermoplastic rubber.

12. The shaving implement of claim 1, wherein the handle includes a release mechanism for releasing the razor cartridge from the handle and a biasing member operable to urge the razor cartridge toward a rest position.

13. The shaving implement of claim 2, wherein the handle includes a neck and wherein the vibration mechanism is positioned between the neck and the razor cartridge.
